(19) United States
(12) Patent Application Publication
(10) Pub. No.: US 2002/0036453 A1
(43) Pub. Date: Mar. 28, 2002

(54) Coil electrode for a fluorescent lamp

(75) Inventor: Erolf Weinhardt, Diedorf (DE)

Correspondence Address: OSRAM SYLVANIA, INC., Attn: Carlo S. Bessone, 100 ENDICOTT STREET, DANVERS, MA, 01923, US

(73) Assignee: Patent-Treuhand-Gesellschaft fur elektrische Gluhlampen mbH

(21) Appl. No.: 09/962,348

(22) Filed: Sep. 26, 2001

(30) Foreign Application Priority Data
Sep. 28, 2000 (DE) 200 16 783.9

(51) Int. Cl. H01K 1/18

(52) U.S. Cl. 313/345

(57) ABSTRACT

A coil electrode for a low-pressure discharge lamp includes a coil body and two coil ends that have connection regions at which they are connected to respective power supply sections. The connection path between the two connection regions is located outside the coil body.

### TECHNICAL FIELD

The invention is based on a coil electrode for a low-pressure discharge lamp, in particular a fluorescent lamp, as claimed in the precharacterizing clause of claim 1. This is, in particular, a coil electrode which has a coil body and two coil ends. In this case, the two coil ends each have a connection region, at which they can be conductively connected to a respective power supply section.

### PRIOR ART

A coil electrode, which is explained in more detail with reference to FIG. 1 in the following text, is already known for use in a fluorescent lamp. The coil electrode 10 illustrated in FIG. 1 has coil ends 12 which run along the coil axis 14 of the coil body 16. Within a fluorescent lamp, the coil ends 12 are connected at their connection regions 18 to power supply sections 20 of the fluorescent lamp, by means of welding or clamping. In contrast to the illustration in FIG. 1, coil electrodes are also known whose coil ends run parallel to the coil axis of the coil body.

In order to make it possible to use the coil electrode for a fluorescent lamp, the coil body must have an emitter pasted to it, normally composed of barium carbonate, strontium carbonate or else calcium carbonate. After the pasting process, the coil electrode is formed. This is a process of converting the emitter applied to the coil electrode to an appropriate oxide (for example barium oxide, strontium oxide or calcium oxide), which is required for charge carrier emission, and thus for operation of the fluorescent lamp. Problems which are caused by the emitter coming into contact with the power supply sections frequently occur during the process of pasting the coil electrode. In this case, it is impossible to carry out the forming process correctly, and the coil electrode together with the connected power supply sections must be scrapped. Particularly in the case of a low-pressure discharge lamp with a small internal bulb diameter and a correspondingly small coil body, it is virtually impossible to prevent the emitter coming into contact with the power supply sections.

A further disadvantage of the already known coil electrode is that droplets are frequently formed on the coil ends immediately after the pasting process and prevent the pasting process and the subsequent forming process from being carried out smoothly.

### DESCRIPTION OF THE INVENTION

The object of the present invention is thus to develop a coil electrode as claimed in the precharacterizing clause of claim 1 in such a manner that the problems described above in the process of pasting the coil body are largely avoided.

For a coil electrode having the features of the precharacterizing clause of claim 1, this object is achieved by a connection path which is formed between the two connection regions of the two coil ends being located outside of the coil body. This is because, in this particular case, the coil body can be immersed in an emitter paste without the connection regions and hence the power supply sections at the same time coming into contact with the emitter. The immersion process allows the coil body to be wetted with a relatively large amount of emitter paste, which essentially governs the life of a fluorescent lamp.

A first advantageous development of the invention provides for the coil body to have a coil axis running in a straight line. This form of coil axis, in particular, ensures uniform charge carrier emission from the coil body.

In a further advantageous refinement of the invention, the coil body has at least one end section which is adjacent to one coil end and has an end section axis, with the adjacent coil end having at least one coil end section between the end section and the connection region, and with the at least one coil end section having a profile which has a direction component that is not equal to zero at every point and is arranged at right angles to the end section axis. This refinement of the invention is particularly advantageous when the at least one coil end section occupies the entire region of the coil end between the end section and the connection region, and when the coil body has a coil axis running in a straight line, or which is only slightly bent. This is because the emitter, which is located on the at least one coil end section, is then passed in the direction of the coil body, and it is possible to avoid droplets being formed on the coil end.

The at least one coil end section may run essentially at right angles to the end section axis. Particularly in the case of a low-pressure discharge lamp having a small internal bulb diameter and a coil electrode which has a coil body with a coil axis running in a straight line, the internal bulb diameter can thus be used entirely for the coil body.

A triple coil electrode, a double coil electrode or a rod coil electrode can be used, in particular, as the coil electrode.

The above object is also achieved by a low-pressure discharge lamp having at least one coil electrode according to the invention.

In this case, the coil electrode may be connected at the two connection regions to the two power supply sections by clamping or by welding.

In one particularly advantageous development, the coil electrode is connected to the two power supply sections without any mechanical stress, either with the low-pressure discharge lamp switched on or with the low-pressure discharge lamp switched off. Such an attachment process without any mechanical stress in one of these states avoids any forces acting on the coil electrode in this state which would reduce its life.

The coil electrode according to the invention is particularly suitable for use in low-pressure discharge lamps which have an internal bulb diameter of less than 8 mm, in particular of 6 mm.

### DESCRIPTION OF THE DRAWINGS

The invention will be explained in more detail in the following text with reference to a number of exemplary embodiments. In the figures:

FIG. 2 shows a schematic illustration of a first embodiment of a coil electrode according to the invention,

FIG. 3 shows a schematic illustration of a second embodiment of a coil electrode according to the invention; and

FIG. 4 shows a schematic illustration of a third embodiment of a coil electrode according to the invention.

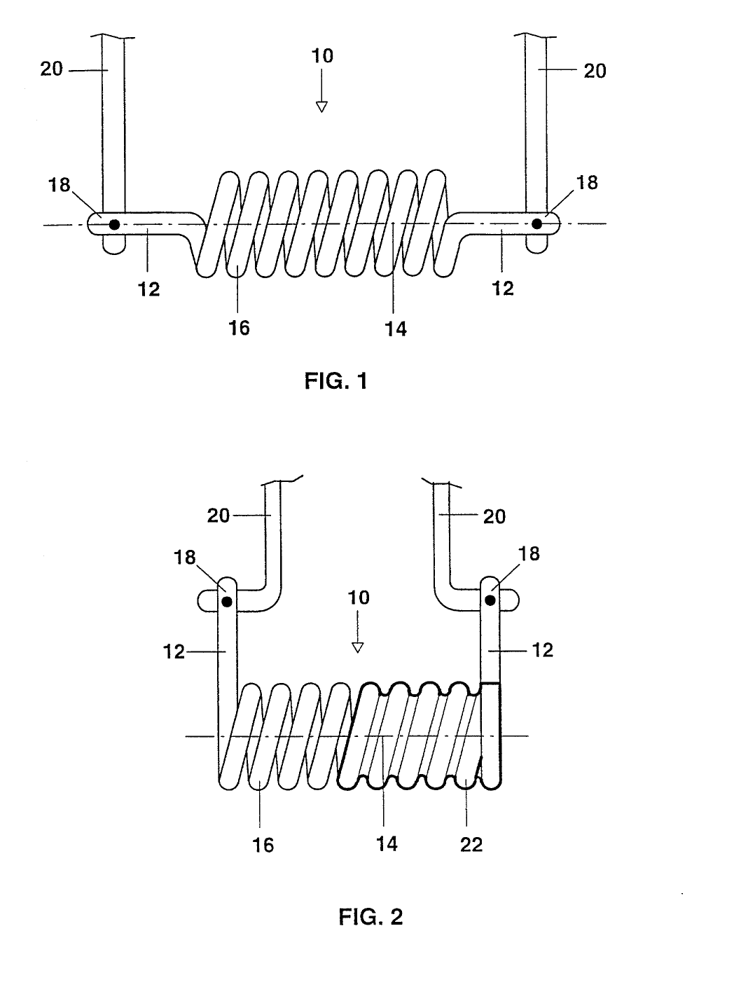

FIG. 2 is a schematic illustration of a first embodiment of a coil electrode 10 according to the invention, which has two coil ends 12 and a coil body 16 with a coil axis 14 running in a straight line. The coil ends 12 are connected at connection regions 18 by welding or clamping to power supply sections 20. In order to wet the coil body 16 with emitter 22, the entire coil body 16 is immersed in an emitter paste 22, with the emitter 22, as shown in FIG. 2, adhering to the coil body. The connection regions 18, and hence the power supply sections 20 as well, in contrast remain free of emitter 22, so that the shaping process can be carried out correctly. If any emitter 22 is likewise located on the coil ends 12, the force of gravity moves this in the direction of the coil body 16. This prevents droplets from being formed on the coil ends 12. The coil electrode 10 is connected to the power supply sections 20 in such a way that there is no mechanical stress on it, at least when no current is flowing through it.

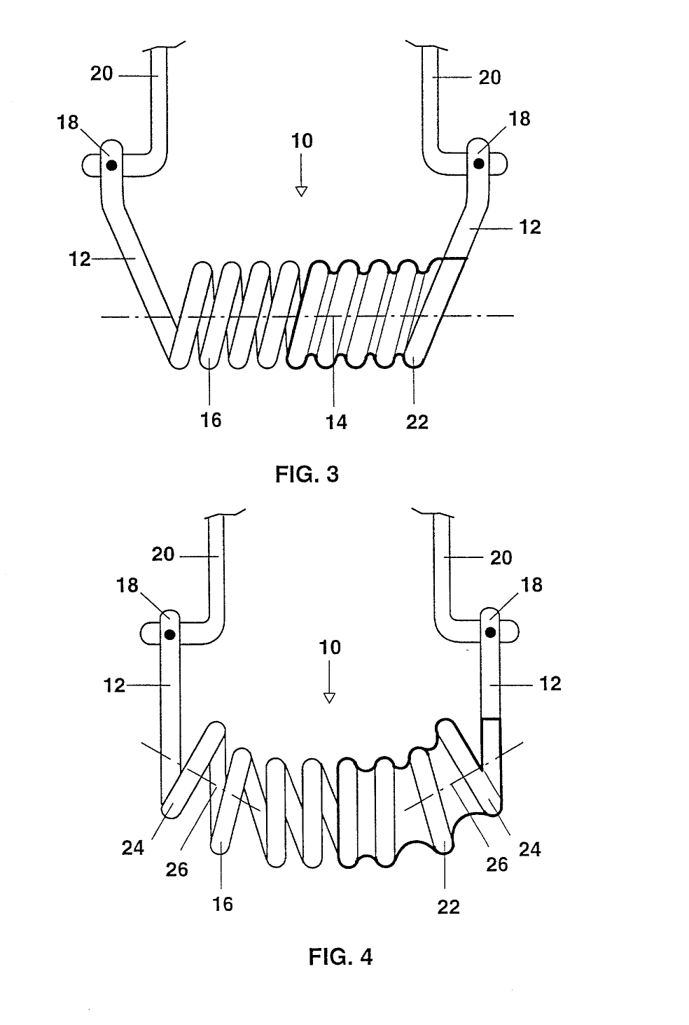

FIG. 3 shows a second embodiment of the coil electrode 10 according to the invention, which likewise has a coil body 16 with a coil axis 14 running in a straight line, and two coil ends 12. However, the coil ends 12 in this embodiment are not arranged at right angles to the coil axis 14, as in the first embodiment. Nonetheless, this profile of the coil ends 12 also leads to any emitter 22 which is located on the coil ends 12 flowing in the direction of the coil body 16. The greater the distance between the connection regions 18 and the coil axis 14, the lower is the probability of the power supply sections 20 being wetted when the emitter 22 is applied by immersing the coil body 16 in an emitter paste 22. This second embodiment is also connected to the power supply sections 20, without any mechanical stress being applied, by welding or clamping. No stresses therefore occur until current is supplied to the coil electrode 10. However, the coil electrode 10 can also be connected to the power supply sections 20 in such a way that it is mounted without any mechanical stress only when a specific current level is supplied to it.

FIG. 4 is a schematic illustration of a third embodiment of the coil electrode 10 according to the invention, which has a curved coil body 16 in a state in which it is connected to the power supply sections 20. This curved coil body 16 has two end sections 24, each having an end section axis 26. The respective coil end 12 adjacent to an end section 24 has a profile which, at every point, has a direction component which is arranged at right angles to the respective end section axis 26. In this refinement of the invention, the coil body 16 is curved only slightly, so that the charge carriers can be emitted virtually uniformly. In this embodiment as well, the emitter 22 can be applied to the coil body 16 by means of an immersion process, and any emitter 22 located on the coil ends 12 can be passed to the coil body 16.

The coil electrode according to the invention appears to be particularly suitable for installation in very small low-pressure discharge lamps, which are known in particular in the form of miniature fluorescent lamps (OSRAM FM/T2) since, in these fluorescent lamps, the emitter pasting process represents a particularly major technical problem which is solved by the invention.

The features of the individual embodiments can be combined.

1. A coil electrode for a low-pressure discharge lamp, with the coil electrode (10) having a coil body (16) and two coil ends (12), with the two coil ends (12) each having a connection region (18) at which they can be conductively connected to a respective power supply section (20), characterized in that a connection path which is formed between the two connection regions (18) of the two coil ends (12) is located outside the coil body (16).

2. The coil electrode as claimed in claim 1, characterized in that the coil body (16) has a coil axis (14) running in a straight line.

3. The coil electrode as claimed in one of claims 1 or 2, characterized in that the coil body (16) has at least one end section (24) which is adjacent to one coil end (12) and has an end section axis (26), with the adjacent coil end (12) having at least one coil end section between the end section (24) and the connection region (18), and with the at least one coil end section having a profile which has a direction component that is not equal to zero at every point and is arranged at right angles to the end section axis (26).

4. The coil electrode as claimed in claim 3, characterized in that the at least one coil end section runs essentially at right angles to the end section axis (26).

5. The coil electrode as claimed in one of claims 1 to 4, characterized in that the coil electrode (10) is a triple coil electrode, a double coil electrode or a rod coil electrode.

6. A low-pressure discharge lamp having at least one coil electrode as claimed in one of claims 1 to 5.

7. The low-pressure discharge lamp as claimed in claim 6, characterized in that the coil electrode (10) is connected at the two connection regions (18) to the two power supply sections (20) by clamping and/or by welding.

8. The low-pressure discharge lamp as claimed in one of claims 6 or 7, characterized in that the coil electrode (10) is connected to the two power supply sections (20) without any mechanical stress, either with the low-pressure discharge lamp switched on or with the low-pressure discharge lamp switched off.

9. The low-pressure discharge lamp as claimed in one of claims 6 to 8, characterized in that the low-pressure discharge lamp has an internal bulb diameter which is less than 8 mm, in particular 6 mm.
